(19) United States
(12) Patent Application Publication
(10) Pub. No.: US 2021/0162329 A1
(43) Pub. Date: Jun. 3, 2021

(54) FILTER LEAKAGE MONITORING DEVICE AND PARTICLE SEPARATOR PROVIDED WITH THE SAME

(71) Applicant: Engineering Crew Ltd., Kitakyushu-shi (JP)

(72) Inventor: Yoichi HORI, Kitakyushu-shi (JP)

(21) Appl. No.: 17/054,461

(22) PCT Filed: Oct. 26, 2018
(86) PCT No.: PCT/JP2018/039961

§ 371 Date: Nov. 10, 2020

(30) Foreign Application Priority Data
May 17, 2018 (JP) 2018-095536

(51) Int. Cl. B01D 46/42; B01D 46/00

(52) U.S. Cl. CPC B01D 46/42; B01D 46/023; B01D 46/0068

(57) ABSTRACT

A filter leakage monitoring device of a particle separator includes a plurality of sampling pipes each of which has a visible part through which an inside of the sampling pipe can be visually recognized, a suction port of each of which corresponds to each of a plurality of filters disposed in a particle-containing air chamber into which air containing particles are introduced, the suction port of each of which is positioned near an air intake port that sucks air that has passed through each of the filters into a clean air chamber, and a vacuum pump that sucks air through each of the sampling pipes.

### BACKGROUND

### Field of the Invention

The present invention relates to a filter leakage monitoring device and a particle separator particle separator provided with the monitoring device. More particularly, the present invention relates to, in, for example, a dust collector or the like that uses a plurality of filters, a device that is capable of identifying a filter that has caused leakage when it has become impossible to normally filter to-be-treated air or the like by monitoring particle leakage from each of the filters.

### Background Art

In workshops, etc., such as various factories, in which dust is easily generated, a dust collector is used in order to improve or excellently maintain a working environment. The dust collector has various dust collection methods, and one of these methods is, for example, a circulation processing method in which an atmosphere in a workshop is sucked in, and various particles (dust) dispersing in the atmosphere are then separated by filters, and clean air obtained here is discharged into the atmosphere. Additionally, a cartridge type filter, such as a bag-shaped filter, is widely used as the filter so that maintenance, such as replacement, can be easily performed.

A dust collector described in, for example, Non-Patent Literature 1 can be mentioned as one example of the dust collector formed as above. In this dust collector, a casing 90 is partitioned into a lower dust-containing air chamber 91 and an upper clean air chamber 92 as shown in FIG. 9, and dust-containing air is treated by a plurality of bag filters 93 disposed in the dust-containing air chamber 91 so that dust is separated from the dust-containing air, and only clean air passes through the clean air chamber 92, and then passes through a discharge pipe 95, and is discharged into outside air (see the left half of FIG. 9). Additionally, dust that has adhered to an outer surface of the bag filter 93 is peeled off by a jet (air wash) of compressed air from the clean-air-chamber-92 side, and can be outwardly discharged by a valve 94 disposed below (see the right half of FIG. 9).

### CITATION LIST

### Patent Literature

Non-Patent Literature 1: Daiichi Filter Kogyo, Ltd., Pulse Jet Type Dust Collector [Searched on Apr. 10, 2018], Internet <http://www5e.biglobe.ne.jp/˜filter/parusujet.htm>

### Technical Problem

However, the conventional dust collector mentioned above has had the following problems.

In detail, there is a case in which the bag filter included in the dust collector is deteriorated by being used for a long time or is damaged by the impact due to the air wash mentioned above, and, as a result, is broken so as to, for example, be torn, thus causing leakage of particles, such as dust, that are to be separated in a normal situation and making it impossible to normally filter air or the like that is to be treated.

In this case, it is economical and preferable to identify a bag filter that has caused leakage and to replace only this bag filter. However, most of the materials for a filtering part of the bag filter or the like are cloth made of various synthetic resin fibers, and are soft and are easily deformed, and therefore it has not been easy to find which part of the material has been broken if a broken part is comparatively small, putting aside a case where the broken part is large. Therefore, practically, it has been difficult to identify which one of the plurality of bag filters has been broken.

Therefore, ordinarily, all of the bag filters are replaced without identifying a bag filter that has caused leakage when it has become impossible to normally filter air or the like that is to be treated as mentioned above. Although it becomes possible to reliably make repairs by replacing all of the bag filters, a bag filter that has not been broken is also replaced and discarded, and therefore a waste of labor-and-time for replacement and a waste of cost have been non-negligible.

Additionally, in the thus-formed dust collector, the number of discharge pipes 95 through which clean air is outwardly discharged might be one if the dust collector is small in size, and yet, in, for example, large-sized dust collectors of a type in which many bag filters are used, there is a dust collector in which many discharge pipes are arranged. In this case, ordinarily, the discharge pipes are arranged side by side in a lateral direction (in a horizontal direction when installed) on the casing 90, etc., and yet, in a dust collector whose performance has been improved by installing bag filters more closely, there has been a problem in the fact that it becomes difficult to arrange discharge pipes because the arrangement of many discharge pipes becomes overcrowded in the lateral direction.

### SUMMARY OF THE INVENTION

The present invention has been made in consideration of these circumstances, and it is an object of the present invention to provide a filter leakage monitoring device that is capable of monitoring leakage of particles from each of a plurality of filters in, for example, a dust collector or the like that uses such a plurality of filters and that is capable of identifying a filter that has caused leakage when it has become impossible to normally filter air or the like that is to be treated, and to provide a particle separator particle separator provided with the monitoring device.

Additionally, it is an object of the present invention to provide a filter leakage monitoring device that is capable of arranging many discharge pipes effortlessly and with enough room even in a dust collector whose performance has been improved by installing bag filters closely together, and to provide a particle separator particle separator provided with the monitoring device.

### Solution to Problem

(1) To achieve the aforementioned objects, a filter leakage monitoring method of a particle separator of the present invention is performed such that, in order to determine that particle leakage has occurred in a filter because of particles flowing through or adhering to the inside of a sampling pipe, air that has passed through each of a plurality of filters from an air intake port that sucks air that has passed through each of the filters into a clean air chamber or from near the air intake port is sucked through the sampling pipe, which corresponds to each of the filters disposed in a particle-containing air chamber into which air containing particles is introduced and which is configured to have a visible part capable of visually recognizing the inside or configured to be capable of detecting particles existing in the inside.

According to the filter leakage monitoring method of the particle separator of the present invention, air that has passed through each of the filters from the air intake port that sucks air that has passed through each of the filters into the clean air chamber or from near the air intake port is sucked through the sampling pipe, which corresponds to each of the plurality of filters disposed in the particle-containing air chamber into which air containing particles is introduced and which is configured to have the visible part capable of visually recognizing the inside or configured to be capable of detecting particles existing in the inside, and, as a result, clean air introduced from the air intake port of the filter or air regarded as being clean enters the sampling pipe, and passes through the inside of the sampling pipe.

If a filtering part of any of the plurality of filters is broken so as to have a hole, when air containing particles in the particle-containing air chamber is sucked from the clean-air-chamber side and passes through the filter, a part of the particles will leak from the hole, and it will become impossible to reliably separate the particles. Particles that have leaked therefrom pass through the inside of the filter together with clean air, and enter the clean air chamber from the air intake port, and yet a part of the particles is sucked together with surrounding air by means of a sampling pipe whose suction port is positioned at the air intake port or is positioned near the air intake port.

Particles that have been sucked by the sampling pipe together with air pass through the inside of the pipe, and a part of the particles adheres to and soils an inner wall of the pipe, and therefore, in the visible part, it is possible to, from outside, visually recognize that the inner wall is dirty. Alternatively, when air containing particles passing through the inside of the pipe is excessively dirty before particles adhere to the inner wall so as to become dirty, it is possible to visually recognize it from outside. Alternatively, it is possible to detect particles passing through the inside of the pipe by means of, for example, various sensors. In any of the aforementioned cases, it is possible to identify a filter that has caused particle leakage by determining that particle leakage has occurred in a filter to which the sampling pipe corresponds.

For example, particles of food powder, or particles of chemical powder, or the like, besides particles of dust, can be mentioned as particles that are separated from air, and yet, without being limited to these particles, the present invention can be applied to particles included in other categories.

A structure in which a visible part for visually recognizing the inside of a sampling pipe is provided is simple and desirable as a structure of each of the sampling pipes, and yet, instead of this, if the structure is formed to include various sensors, such as a photoelectric sensor or an infrared ray sensor, that detect particles passing through the inside of the pipe, an artificial determination will be excluded, and therefore it can be expected that it becomes possible to identify a defective filter more swiftly and more reliably.

(2) To achieve the aforementioned objects, a filter leakage monitoring device of a particle separator of the present invention includes a plurality of sampling pipes each of which is configured to have a visible part through which an inside of the sampling pipe can be visually recognized or each of which is configured so that particles inside the sampling pipe are detectable, a suction port of each of which corresponds to each of a plurality of filters disposed in a particle-containing air chamber into which air containing particles is introduced, the suction port of each of which is positioned at an air intake port that sucks air that has passed through each of the filters into a clean air chamber or is positioned near the air intake port, and a suction device that sucks air through each of the sampling pipes.

According to the filter leakage monitoring device of the present invention, the sampling pipe is configured to have the visible part capable of visually recognizing the inside of the sampling pipe or configured to be capable of detecting particles existing in the inside, and the suction port corresponds to each of the plurality of filters disposed in the particle-containing air chamber into which air containing particles is introduced, and it is possible to suck air by means of the suction device through each of the sampling pipes from the intake port that sucks air that has passed through each of the filters into the clean air chamber or from near the air intake port. Hence, clean air introduced from the air intake port of the filter or air regarded as being clean passes through the inside of the sampling pipe.

If a filtering part of any of the plurality of filters is broken so as to have a hole, when air containing particles in the particle-containing air chamber is sucked from the clean-air-chamber side and passes through the filter, a part of the particles will leak from the hole, and it will become impossible to reliably separate the particles. Particles that have leaked therefrom pass through the inside of the filter together with clean air, and enter the clean air chamber from the air intake port, and yet a part of the particles is sucked together with surrounding air by means of a sampling pipe whose suction port is positioned at the air intake port or is positioned near the air intake port.

Particles that have been sucked by the sampling pipe together with air pass through the inside of the pipe, and a part of the particles adheres to and soils an inner wall of the pipe, and therefore, in the visible part, it is possible to, from outside, visually recognize that the inner wall is dirty. Alternatively, when air containing particles passing through the inside of the pipe is excessively dirty before particles adhere to the inner wall so as to become dirty, it is possible to visually recognize it from outside. Alternatively, it is possible to detect particles passing through the inside of the pipe by means of, for example, various sensors. In any of the aforementioned cases, it is possible to recognize that particle leakage has occurred in a filter to which the sampling pipe corresponds, and it is possible to identify a filter that has caused particle leakage.

The term “suction device” mentioned in the claims denotes a device capable of making negative pressure (for example, air pressure lower than the atmospheric pressure) of a vacuum pump, or a blower, or the like, and its method and its structure are not restricted.

(3) The present invention may be configured such that a suction/discharge passage through which air is sucked and discharged by the suction device is connected to a discharge passage through which clean air passing through the clean air chamber is sucked and discharged outwardly from the device.

In this case, when particle leakage has occurred in a filter, particles that have passed through this filter and through the inside of the sampling pipe meet clean air passing through the discharge passage together with clean air passing through another sampling pipe, and are discharged to external air existing outside the device. If a suction passage is configured to be connected to the discharge passage, it is also possible to employ a configuration formed such that air passing through each of the sampling pipes is sucked by using the suction force of the suction device, for example, without providing the suction device at the suction passage.

(4) The present invention may be configured such that the sampling pipes corresponding to the filters that are arranged side by side and that are respectively identical in row with the sampling pipes are disposed in a lengthwise arrangement.

In this case, the plurality of sampling pipes are disposed in a lengthwise arrangement (arrangement in the vertical direction), and, as a result, a laterally (horizontally) larger space for arranging the sampling pipes side by side is not required than in a configuration in which the sampling pipes are disposed in a lateral arrangement. This makes it possible to arrange many sampling pipes each of which is a discharge pipe effortlessly and with enough room so as not to become overcrowded even if it is a dust collector whose performance has been improved by closely installing bag filters.

(5) To achieve the aforementioned objects, a particle separator of the present invention includes a particle-containing air chamber that is provided with a plurality of filters and into which particle-containing air that contains particles is introduced, a clean air chamber that is divided from the particle-containing air chamber by means of the filters and into which air that has passed through the filters is introduced, a plurality of sampling pipes that are disposed in the clean air chamber each of which is configured to have a visible part through which an inside of the sampling pipe can be visually recognized or each of which is configured so that particles inside the sampling pipe are detectable, a suction port of each of which corresponds to each of a plurality of filters disposed in a particle-containing air chamber into which air containing particles is introduced, the suction port of each of which is positioned at an air intake port that sucks air that has passed through each of the filters into the clean air chamber or is positioned near the air intake port, and a filter leakage monitoring device having a suction device that sucks air through each of the sampling pipes.

According to the particle separator of the present invention, air is sucked from the clean-air-chamber side, and, as a result, particle-containing air that contains particles is introduced into the particle-containing air chamber. The particle-containing air passes through the filter, and particles in the particle-containing air are filtered off, and are separated from air. Clean air from which particles have been separated enters the clean air chamber from the air intake port, and is sent to a discharge passage connected to the clean air chamber, and is discharged into external air.

Additionally, clean air introduced from the air intake port of the filter or air regarded as being clean is sucked by the suction device through each of the sampling pipes, and passes through the inside of the sampling pipe. If any of the plurality of filters is broken so as to have a hole, when air containing particles in the particle-containing air chamber passes through the filter, a part of the particles will leak from the hole, and it will become impossible to reliably separate the particles.

Additionally, particles that have leaked therefrom pass through the filter together with clean air, and enter the clean air chamber from the air intake port, and a part of the particles is sucked by the suction device through a sampling pipe corresponding to a filter that has occurred leakage together with its surrounding air. Particles that have been sucked by the sampling pipe together with air pass through the inside of the pipe, and a part of the particles adheres to and soils an inner wall of the pipe, and therefore, in the visible part, it is possible to, from outside, visually recognize that the inner wall is dirty.

Alternatively, when air containing particles passing through the inside of the pipe is excessively dirty before particles adhere to the inner wall so as to become dirty, it is possible to visually recognize it from outside. Alternatively, it is possible to detect particles passing through the inside of the pipe by means of, for example, various sensors. In any of the aforementioned cases, it is possible to recognize that particle leakage has occurred in a filter to which the sampling pipe corresponds, and it is possible to identify a filter that has caused particle leakage.

(6) The present invention may be configured such that mutually different symbols are respectively assigned to the filters and are displayed, and a symbol identical with the symbol of each of the filters corresponding each of the sampling pipes is assigned to the sampling pipe and is displayed.

In this case, if the visible part of one of the sampling pipes that displays a symbol is dirty, it is understood that leakage has occurred in one of the filters that displays the same symbol as that of the sampling pipe that is dirty. As thus described, it is possible to easily and reliably identify a filter that has been broken by collating the symbols with each other.

The term “symbol” mentioned in the claims includes letters, numeric characters, marks, emblems, etc., that are used to represent predetermined contents.

A dust collector can be mentioned as an example of the particle separator provided with the filter leakage monitoring device. Additionally, a powder mixer (blender) to which a function to stir a plurality of kinds of powders and to mix the powders together at an appropriate ratio is added can be mentioned as a device in which other functionalities are added to the particle separator.

### Advantages of the Invention

The present invention is capable of providing a filter leakage monitoring device that is capable of monitoring leakage of particles from each of a plurality of filters in, for example, a dust collector or the like that uses such a plurality of filters and that is capable of identifying a filter that has caused leakage when it has become impossible to normally filter air or the like that is to be treated, and providing a particle separator particle separator provided with the monitoring device.

Additionally, a plurality of sampling pipes are disposed in a lengthwise arrangement (arrangement in the vertical direction), and, as a result, a laterally (horizontally) larger space for arranging the sampling pipes side by side is not required than in a configuration in which the sampling pipes are disposed in a lateral arrangement. This makes it possible to arrange many sampling pipes each of which is a discharge pipe effortlessly and with enough room so as not to become overcrowded even if it is a dust collector whose performance has been improved by closely installing bag filters.

### BRIEF DESCRIPTION OF THE DRAWINGS

FIG. 1 is a descriptive front view showing a first embodiment of a particle separator according to the present invention;

FIG. 2 is a descriptive plan view of the particle separator according to the present invention;

FIG. 3 is a descriptive lateral view of the particle separator according to the present invention;

FIG. 4 shows a main part of a sampling pipe of the particle separator of FIGS. 1 to 3, in which FIG. 4A is a descriptive enlarged view of a P1 part of FIG. 1, FIG. 4B is a descriptive enlarged view of a P2 part of FIG. 2, and FIG. 4C is a descriptive enlarged view of a P3 part of FIG. 3;

FIG. 5 is a descriptive enlarged view of a P part of FIG. 4C;

FIG. 6 shows a second embodiment of the particle separator according to the present invention, in which FIG. 6A is a descriptive front view, and FIG. 6B is a descriptive plan view;

FIG. 7 is a descriptive enlarged view of a P4 part showing a main part of a sampling pipe of the particle separator of FIG. 6;

FIG. 8 is a descriptive view showing a third embodiment of the particle separator according to the present invention; and

FIG. 9 is a descriptive view showing a structure of a dust collector described in Non-Patent Literature 1.

DESCRIPTION OF THE EMBODIMENTS

Embodiments of the present invention will be described in more detail.

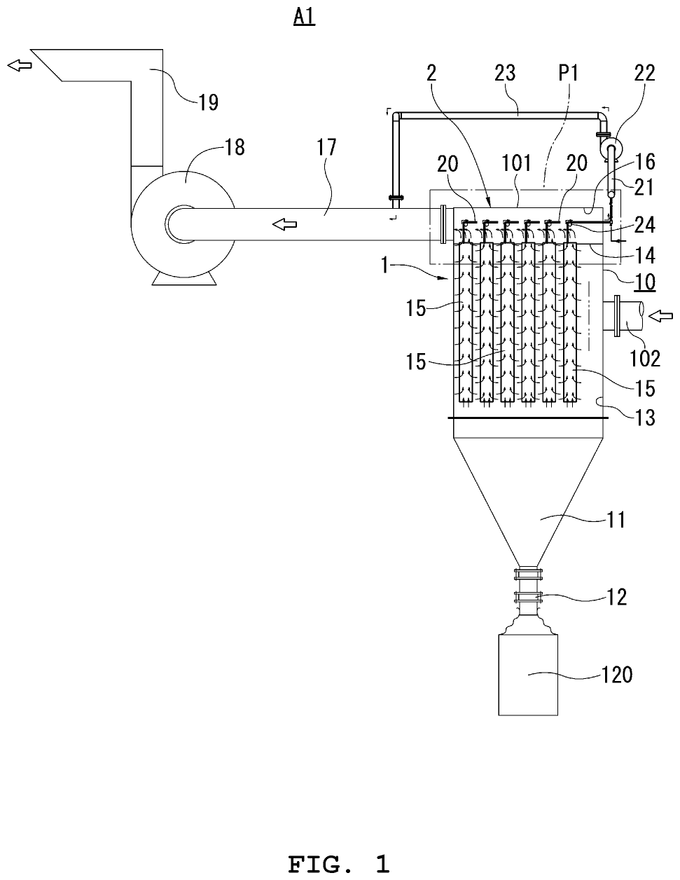

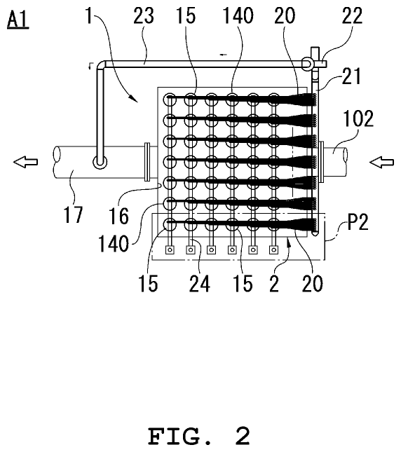

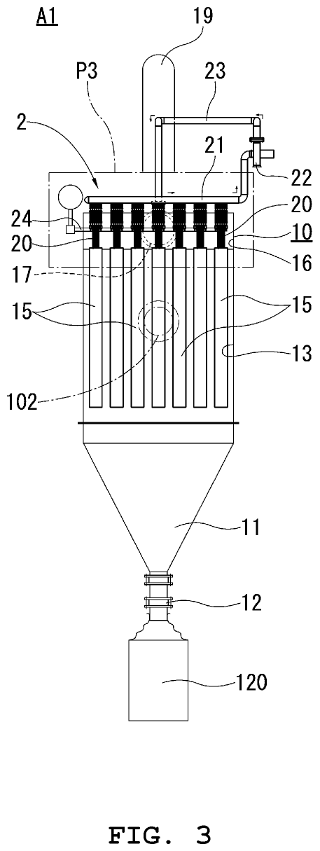

Referring to FIG. 1 to FIG. 4, a description will be given of a structure of a dust collector A1 that is a first embodiment of a particle separation device according to the present invention. It should be noted that a barrel part of a casing body is partially omitted in FIG. 1, an upper surface plate of the casing body is omitted in FIG. 2, and the barrel part of the casing body is partially omitted in FIG. 3, so that bag filters disposed inside appear.

The dust collector A1 includes a casing 1, a filter leakage monitoring device 2, and a vacuum pump 18. The casing 1 includes a casing body 10 whose barrel part formed in a quadrangular cylindrical shape and whose upper part is closed with an upper surface plate 101 and a hopper 11 that is disposed at a lower part of the casing body 10 and that downwardly becomes narrower. A double damper 12 that transfers particles, which have been separated and collected, to a dust collection container 120 is attached to a lower end part of the hopper 11. The double damper 12 has a structure in which two valves are placed on upper and lower sides, respectively, and discharges particles to the dust collection container 120, which is detachable, while opening and closing each of the valves in a time-difference manner.

In the casing 1, a particle-containing air chamber 13 into which particle-containing air that contains particles is introduced is formed on the lower-part side, whereas a clean air chamber 16 through which clean air, from which particles have been separated, passes is disposed on the upper-part side. The particle-containing air chamber 13 and the clean air chamber 16 are divided from each other by means of a divider plate 14 and a plurality of bag filters 15. Additionally, an introduction pipe 102 that introduces external air (particle-containing air) into the particle-containing air chamber 13 is disposed at a sidewall (whose reference sign is omitted) of the particle-containing air chamber 13.

Each of the bag filters 15 has a bag part formed in a bottomed cylindrical shape (whose reference sign is omitted), and the bag part is made of synthetic resinous cloth that has a texture that is capable of filtering and separating particles each of which has a fixed size. With respect to this texture, a texture size that can correspond to the size of a to-be-separated particle is appropriately employed. Additionally, a reinforcing frame (not shown) of a synthetic-resin-made wire rod or the like is lined on the inner-surface side of the bag part so that the bag part is not destroyed by a difference in air pressure between the inside and the outside.

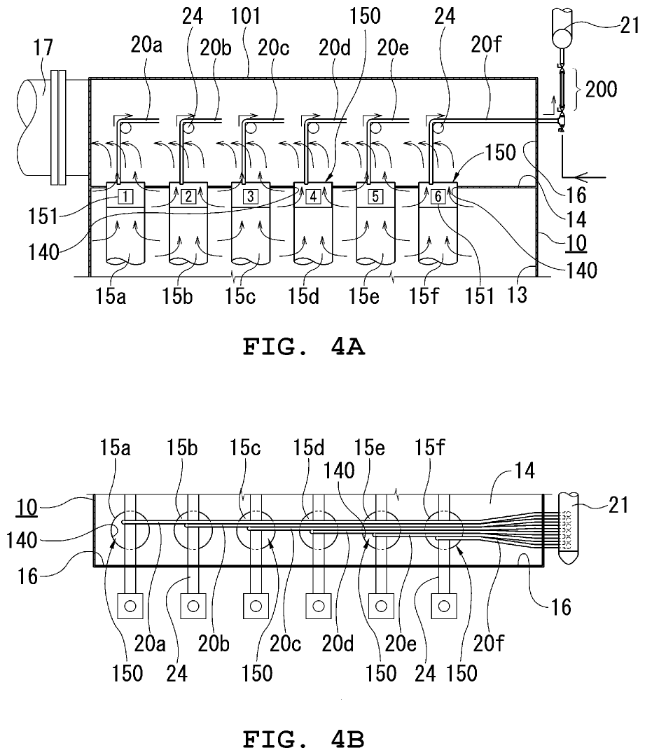

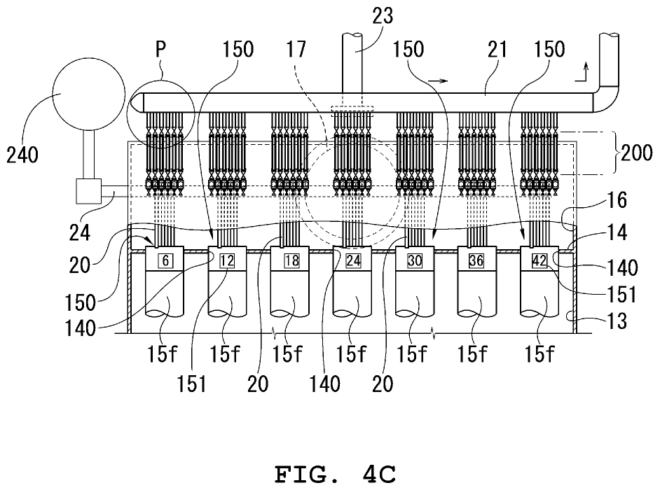

In the bag filter 15, the opening side of the bag part is attached to a circular installation port 140 (also see FIG. 4) that is formed at seven places vertically, at six places laterally, and at forty-two places in total of the divider plate 14 in FIG. 2. Each of the bag filters 15 is formed so that an air intake port 150 is open toward the clean-air-chamber-16 side as shown in FIG. 1 and FIG. 4A that is an enlarged view of the P1 part, and the bag part is positioned on the particle-containing-air-chamber-13 side, and is disposed so that the bag parts uniformly droop down. Hence, clean air from which particles have been separated in each of the bag filters 15 is sucked from the air intake port 150 into the clean air chamber 16.

A plurality of metallic sampling pipes 20 that are constituents of the filter leakage monitoring device 2 are disposed in the clean air chamber 16. The sampling pipes 20 are each extended from the air intake port 150 of each of the bag filters 15 in the lateral direction in FIG. 2, and are arranged side by side in the horizontal direction when installed. In detail as shown in FIG. 4B (an enlarged view of the P2 part of FIG. 2), a sampling pipe 20a whose front-end suction port (reference sign omitted) is positioned near the air intake port 150 of the leftmost bag filter 15a is hung at a pulse-jet pipe 24 laid horizontally, and is extended as above, and is connected to an air intake pipe 21. The material of the sampling pipe 20 is not limited to a metallic material, and any kind of material (for example, synthetic resin) may be employed.

The pulse-jet pipe 24 is provided with an air receiver tank 240 at its end side, and air washing can be performed such that particles, such as dust, that have adhered to an outer surface of the bag filter 15 are peeled off by a jet (pulse jet) of compressed air from the pulse-jet pipe 24 disposed on the clean-air-chamber-16 side by use of the air receiver tank 240 while operating the dust collector A1.

Likewise, a sampling pipe 20b is extended from a bag filter 15b, a sampling pipe 20c is extended from a bag filter 15c, a sampling pipe 20d is extended from a bag filter 15d, a sampling pipe 20e is extended from a bag filter 15e, and a sampling pipe 20f is extended from a bag filter 15f successively, and is connected to the air intake pipe 21 that is disposed outside the casing 1 and that is laid in the horizontal direction.

Additionally, in each of the sampling pipes 20 (in the description of FIG. 4, the sampling pipes 20a to 20f), visible parts 200 that are arranged side by side in the direction along the air intake pipe 21 and each of which uniformly has a predetermined length are formed before entering the air intake pipe 21. The visible part 200 is placed in the vertical direction, and is made of transparent synthetic resin unlike other parts of each of the sampling pipes 20, thus making it possible to see the inside of the pipe from the outside through the visible part 200 (see FIG. 4C that is an enlarged view of the P3 part of FIG. 3).

Valves (whose reference sign is omitted) are respectively disposed at both ends of the visible part 200 in a direction in which intake air flows, thus making it possible to perform switching between the passage and the blockage of intake air. The material of the visible part 200 is not limited to synthetic resin, and the visible part 200 can be made of another material, such as tempered glass or heat-resistant glass.

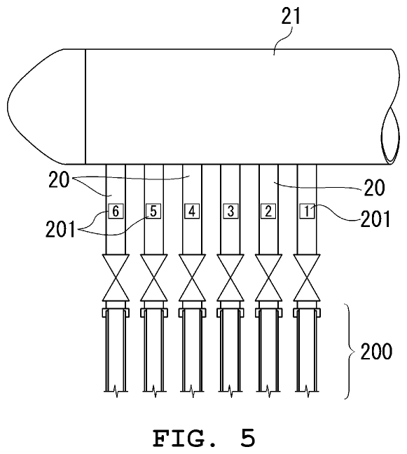

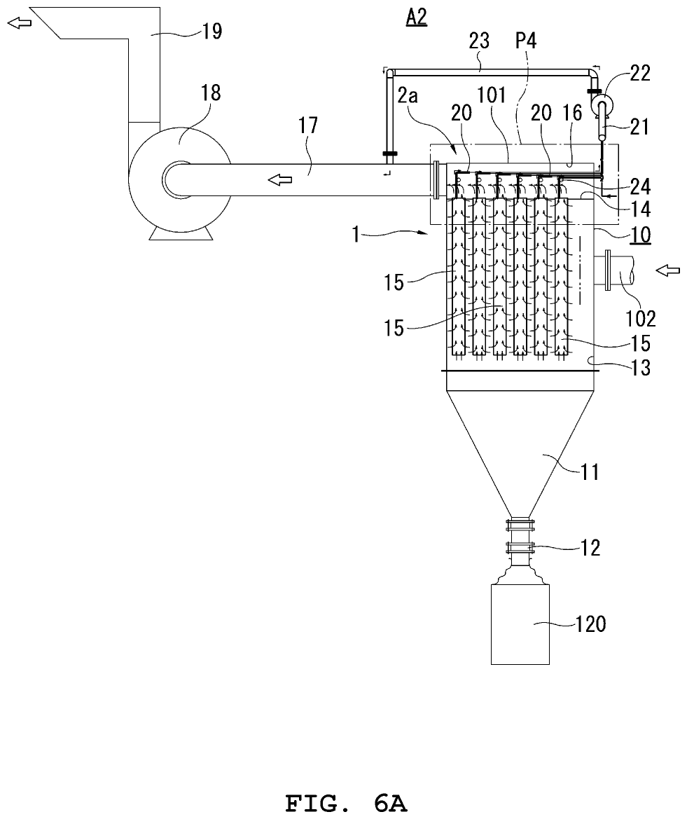

Additionally, in each of all the forty-two bag filters 15, a number 151 is assigned and displayed on an attachment piece (whose reference sign is omitted) of each of the bag filters 15 in the manner of consecutive numbers “1 to 42” (see FIGS. 4A and 4C). Additionally, likewise, a number 201 is assigned and displayed on each of all the forty-two sampling pipes 20 corresponding to each of the bag filters 15 in the manner of consecutive numbers “1 to 42” (see FIG. 5). In FIG. 4 and FIG. 5 that is an enlarged view of the P part of FIG. 4C, the number 151 of each of the bag filters 15 and the number 201 of each of the sampling pipes 20 are partially omitted and are partially not displayed for drawing convenience.

It is possible to visually recognize the number 151 of each of the bag filters 15 by opening a door (whose reference sign is omitted) of the casing 1. Additionally, the number 151 is displayed on the attachment piece, and therefore, if a bag filter has become defective, it is only necessary to replace only a filter body, which is a common spare part, with another, hence enabling an economical operation. Additionally, likewise, in a particle separation device A2 described later, it is possible to number each of the bag filters 15 and each of the sampling pipes 20.

The air intake pipe 21 mentioned above is connected to the intake side of a vacuum pump 22 that is a suction device. An exhaust pipe 23 is connected to the exhaust side of the vacuum pump 22. On the other hand, an air intake pipe 17 is connected to the clean air chamber 16. The air intake pipe 17 is connected to the intake side of the vacuum pump 18. An exhaust pipe 19 is connected to the exhaust side of the vacuum pump 18 (see FIG. 1). The exhaust pipe 23 mentioned above is connected to a part closer to a base end of the exhaust pipe 19.

It is also possible not to contaminate external air by providing the exhaust pipe 19 with a filter even when particles have leaked. Additionally, air that has passed through the exhaust pipe 23 may be discharged directly to external air without connecting the exhaust pipe 23 to the exhaust pipe 19. In that case, it is preferable not to contaminate external air by providing the exhaust pipe 23 with a filter even when particles have leaked, and yet the present invention is not limited to this configuration.

(Operation)

The operation of the dust collector A1 will be described with reference to FIG. 1 to FIG. 4. In the dust collector A1, the inside of the casing 1 becomes negative in pressure by operating the vacuum pump 18. Hence, air (external air that contains particles, such as dust) is taken in from the introduction pipe 102, and air taken in the casing 1 is drawn by the vacuum pump 18, and continuously flows from the particle-containing air chamber 13 to the clean air chamber 16.

When air moves from the particle-containing air chamber 13 to the clean air chamber 16, the air passes through each of the bag filters 15, and particles, such as dust, in the air are filtered, and adhere to the outer surface of each of the bag filters 15, and are separated as shown by the arrows in FIG. 1 and FIG. 4A. The air (hereinafter, referred to as clean air) from which particles have been separated and that has become clean enters the clean air chamber 16, and then passes through the air intake pipe 17 connected to the vacuum pump 18, and is discharged from the exhaust pipe 19 into external air. This makes it possible to improve a working environment while gradually cleaning the air in a workshop or the like.

On the other hand, the clean air from which particles have been separated with each of the bag filters 15 by means of the filter leakage monitoring device 2 included in the dust collector A1 is sucked by the vacuum pump 22 from near the air intake port 150 formed on the clean-air-chamber-16 side through each of the sampling pipes 20. The clean air passing through each of the sampling pipes 20 passes through the visible part 200 disposed in a route, and then passes through the exhaust pipe 23, and gathers at the air intake pipe 17 mentioned above.

If a filtering part of any of the plurality of bag filters 15 is broken so as to have a hole, when air containing particles in the particle-containing air chamber 13 is sucked from the clean-air-chamber-16 side and passes through the bag filter 15, a part of the particles will leak from the hole, and it will become impossible to reliably separate the particles. Particles that have leaked therefrom pass through the inside of the bag filter 15 together with clean air, and enter the clean air chamber 16 from the air intake port 150, and yet a part of the particles is sucked together with surrounding air by means of the sampling pipe 20 whose suction port is positioned near the air intake port 150.

Particles that have been sucked by the sampling pipe 20 together with air pass through the inside of the pipe, and a part of the particles adheres to and soils the inner wall of the pipe, and therefore, in the visible part 200, it is possible to, from outside, visually recognize that the inner wall is dirty. Alternatively, when air containing particles passing through the inside of the pipe is excessively dirty before particles adhere to the inner wall so as to become dirty, it is possible to visually recognize it from outside.

If particles adhere to the inside of the sampling pipe 20 so that the inner surface of the pipe becomes dirty, it is possible to remove particles adhering thereto by means of an airflow by temporarily closing the valve and then opening it at once and by allowing air to rapidly pass during operation.

In any of the aforementioned cases, it is possible to understand that particle leakage has occurred in a bag filter 15 to which the sampling pipe 20 corresponds, and it is possible to identify a bag filter 15 that has caused particle leakage.

In other words, if the visible part 200 of the number 201 that displays “2” is dirty among the numbers 201 of the sampling pipes 20 in, for example, FIG. 5, it is understood that leakage has occurred in the bag filter 15 that displays “2” that is the same number among the numbers 151 of the bag filters 15. As thus described, it is possible to easily and reliably identify a bag filter that has been broken by collating the numbers 201 and 151 with each other.

Hence, likewise, when leakage has occurred in a bag filter 15, it is only necessary to replace only the bag filter 15 that has caused leakage, and therefore it is possible to eliminate a waste of labor-and-time for replacement of all filters, which has been performed in a conventional technique, and a waste of cost.

In the dust collector A1, the exhaust pipe 23, through which exhaust gases are discharged by the vacuum pump 22, is connected to the air intake pipe 17, which is connected to the vacuum pump 18 that sucks clean air passing through the clean air chamber 16 and discharges it outwardly from the device through the exhaust pipe 19. Hence, when particle leakage has occurred in a bag filter 15, particles that have passed through the inside of the sampling pipe 15 that has sucked the particles meet clean air passing through the air intake pipe 17 together with clean air passing through the other sampling pipes 15, and are discharged from the exhaust pipe 19 into external air outside the device.

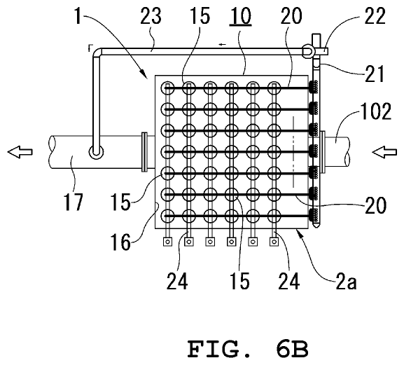

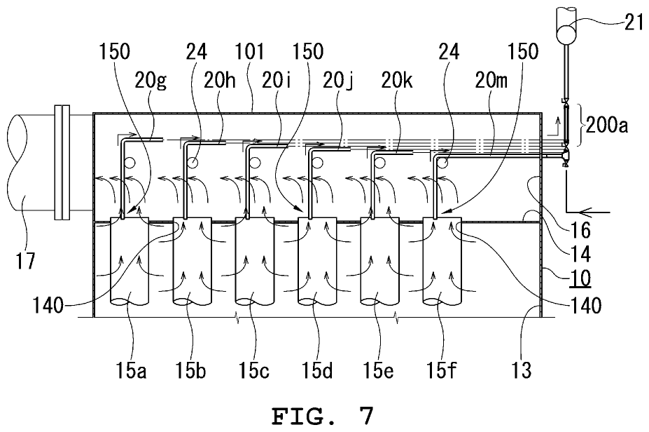

Referring to FIG. 6 and FIG. 7, a description will be given of a structure of a dust collector A2 that is a second embodiment of the particle separation device according to the present invention. It should be noted that a barrel part of a casing body is partially omitted in FIG. 6A, and an upper surface plate of the casing body is omitted in FIG. 6B, and the barrel part of the casing body is omitted in FIG. 7, so that a bag filter disposed inside appears.

The dust collector A2 has the same structure as the aforementioned dust collector A1 excluding a configuration in which sampling pipes 20 each of which is a constituent of a filter leakage monitoring device 2a and that respectively correspond to bag filters 15, which are arranged side by side and which are respectively identical in row with the sampling pipes 20, are disposed in a lengthwise arrangement (arrangement it the vertical direction when installed). In the following description, only a difference mentioned above in comparison with the dust collector A1 is described, and a description of the other parts is omitted, and, in FIG. 6 and FIG. 7, a same reference sign is given to a component equivalent to each component of the dust collector A1, and the description of the dust collector A1 is quoted herein.

This embodiment is described with reference chiefly to FIG. 7 that is an enlarged view of the P4 part of FIG. 6A. The sampling pipes 20 are each extended from the air intake port 150 of each of the bag filters 15 in the lateral direction in FIG. 6, and are disposed so as to be arranged in the vertical direction when installed. In detail, a sampling pipe 20g whose front-end suction port (whose reference sign is omitted) is positioned near the air intake port 150 of the leftmost bag filter 15a is extended as above, and is connected to the air intake pipe 21.

Likewise, a sampling pipe 20h is extended from the bag filter 15b while passing directly below the sampling pipe 20g, and a sampling pipe 20i is extended from the bag filter 15c while passing directly below the sampling pipe 20h.

Furthermore, a sampling pipe 20j is extended from the bag filter 15d while passing directly below the sampling pipe 20i, and a sampling pipe 20k is extended from the bag filter 15e while passing directly below the sampling pipe 20j, and a sampling pipe 20m is extended from the bag filter 15f while passing directly below the sampling pipe 20k successively, and is connected to the air intake pipe 21 that is disposed outside the casing 1.

In the present embodiment, parts of the sampling pipes 20 each of which serves as a visible part 200a are arranged side by side along the air intake pipe 21 in the same way as the visible part 200 of the dust collector A1, so that the inside of a sampling pipe 20 corresponding to a bag filter 15 that has caused particle leakage can be easily seen through the visible part 200a.

The dust collector A2 is configured as above, and the plurality of sampling pipes 20 are disposed in a lengthwise arrangement, i.e., are disposed to be arranged in the vertical direction when installed, and, as a result, a laterally larger space for arranging the sampling pipes 20 side by side is not required than in a configuration in which the sampling pipes 20 are laterally arranged as in the dust collector A1. This makes it possible to arrange many sampling pipes each of which is a discharge pipe effortlessly and with enough room so as not to become overcrowded even if it is a dust collector whose performance has been improved by closely installing the bag filters.

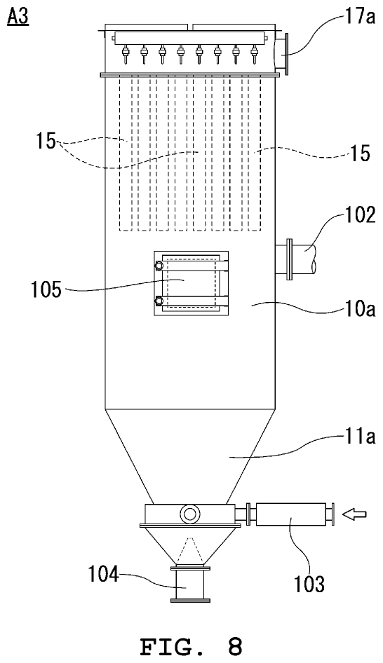

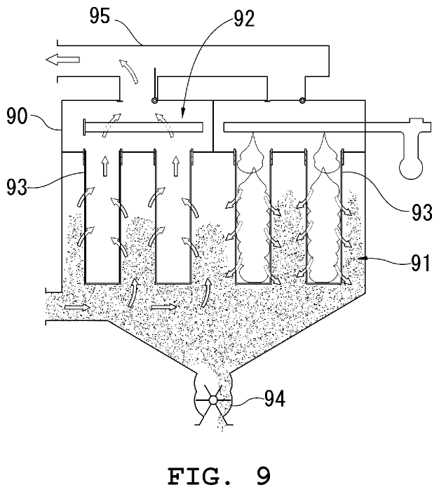

Referring to FIG. 8, a description will be given of a structure of a powder mixer A3 that is a third embodiment of the particle separation device according to the present invention. The powder mixer A3 is a so-called blender, and is to evenly mix powders of, for example, foods or medicines at a predetermined ratio.

In the powder mixer A3, the clean air chamber 16 leading to an air intake pipe 17a and the particle-containing air chamber 13 that is a mixing chamber (both of which are not shown) are disposed in a casing 10a, and, in the particle-containing air chamber 13, the plurality of bag filters 15 are arranged in the same way as in the dust collector A1, and the filter leakage monitoring device 2 (not shown) is disposed.

According to the powder mixer A3, it is possible to stir a plurality of kinds of powders introduced into the casing 10a through the introduction pipe 102 by means of compressed air supplied from a compressed-air supply part 103 laterally connected to a lower part of a hopper 11a and is possible to discharge evenly-mixed powders outwardly from a discharge valve 104. It is possible to see how the powders are being stirred through a peephole 105.

Additionally, in the powder mixer A3, the internal pressure is maintained near the atmospheric pressure during a stirring operation, and therefore compressed air introduced thereinto is required to be discharged outwardly therefrom. At this time, to avoid allowing powders floating in the particle-containing air chamber 13 to be discharged outwardly together with air, powders are separated by the bag filter 15 in the same way as in the dust collector A1, and air is discharged into external air through the air intake pipe 17a.

If any of the bag filters 15 is broken, and powder leakage occurs, it is possible to identify a bag filter 15 that has caused leakage by visually recognizing dirt, which is caused by the passage of powders, of a sampling pipe 20 corresponding to each of the bag filters 15 in the same way as in the dust collector A1. Hence, likewise, when leakage has occurred in a bag filter 15, it is only necessary to replace only the bag filter 15 that has caused leakage, and therefore it is possible to eliminate a waste of labor-and-time for replacement of all filters, which has been performed in a conventional technique, and a waste of cost.

Terms and expressions used in the description and in the claims are thoroughly explanatory ones, i.e., are not limiting ones at all, and there is no intention of excluding characteristics mentioned in the description and in the claims and no intention of excluding terms and expressions that are equivalent to a part the characteristics. Additionally, of course, various modifications can be carried out within the range of the technical thought of the present invention.

### DESCRIPTION OF REFERENCE NUMERALS

A1: Dust collector

1: Casing

10: Casing body

101: Upper surface plate

102: Introduction pipe

11: Hopper

12: Double damper

120: Dust collection container

13: Particle-containing air chamber

14: Divider plate, 140: Installation port

15 (15a to 15f): Bag filter

150: Air intake port

151: Filter number

16: Clean air chamber

17: Air intake pipe

18: Vacuum pump

19: Exhaust pipe

2: Filter leakage monitoring device

20 (20a to 20f): Sampling pipe

200: Visible part

201: Sampling-pipe number

21: Air intake pipe

22: Vacuum pump

23: Exhaust pipe

24: Supporting member

240: Air receiver tank

A2: Dust collector

2a: Filter leakage monitoring device

20g to 20m: Sampling pipe

200a: Visible part

A3: Powder mixer

10a: Casing

103: Compressed-air supply part

104: Discharge valve

105: Peephole

11a: Hopper

17a: Air intake pipe

1. A filter leakage monitoring device of a particle separator comprising:
a plurality of sampling pipes wherein each of the sampling pipes is configured to have a visible part through which an inside of the sampling pipe can be visually recognized, or each of the sample pipes is configured so that particles inside the sampling pipe are detectable; and
a suction device that sucks air through each of the sampling pipes,
wherein each of the plurality of sampling pipes include a suction port that corresponds to a filter disposed in a particle-containing air chamber,
wherein the particle-containing air chamber is constructed such that air containing particles are introduced therein,
wherein the suction ports are positioned at an air intake port that sucks air that has passed through each of the filters into a clean air chamber, or the suction ports are positioned near the air intake port,
wherein the sampling pipes are disposed in a lengthwise arrangement, and
wherein the filters corresponding to the sampling pipes are arranged side by side and are respectively and substantially identical in row with the sampling pipes.

2. The filter leakage monitoring device of the particle separator according to claim 1, wherein a suction/discharge passage through which the air is sucked and discharged by the suction device is connected to a discharge passage through which clean air passing through the clean air chamber is sucked and discharged outwardly from the filter leakage monitoring device.

3. A particle separator comprising:
a particle-containing air chamber which includes a plurality of filters, into which particle-containing air is introduced;
a clean air chamber that is divided from the particle-containing air chamber by the filters and into which air that has passed through the filters is introduced;
a plurality of sampling pipes that are disposed in the clean air chamber, each of the sampling pipes is configured to have a visible part through which an inside of the sampling pipe can be visually recognized, or each of the sampling pipes is configured so that particles inside the sampling pipe are detectable; and
a suction device that sucks air through each of the sampling pipes,
wherein each of the plurality of sampling pipes include a suction port that corresponds to a filter disposed in a particle-containing air chamber,
wherein the particle-containing air chamber is constructed such that air containing particles are introduced therein,
wherein the suction ports are positioned at an air intake port that sucks air that has passed through each of the filters into a clean air chamber, or the suction ports are positioned near the air intake port,
wherein the sampling pipes are disposed in a lengthwise arrangement, and
wherein the filters corresponding to the sampling pipes are arranged side by side and are respectively and substantially identical in row with the sampling pipes.

4. The particle separator according to claim 3, wherein mutually different symbols are respectively assigned to the filters and are displayed, and
wherein a symbol identical with the symbol displayed on the filter corresponding to each of the sampling pipes is assigned to the sampling pipe and is displayed.
